(19) United States
(12) Patent Application Publication
(10) Pub. No.: US 2008/0003394 A1
(43) Pub. Date: Jan. 3, 2008

(54) CARD HAVING A DECORATIVE FIBER LAYER AND PROCESS FOR MAKING

(75) Inventor: Daniel A. Eke, Andover, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Travel Tags, Inc., North Mankato, MN (US)

(21) Appl. No.: 11/769,298

(22) Filed: Jun. 27, 2007

Related U.S. Application Data
(60) Provisional application No. 60/816,701, filed on Jun. 27, 2006.

(51) Int. Cl. B32B 33/00; B32B 7/00; B44C 1/165

(52) U.S. Cl. 428/41.8; 156/230; 428/206

(57) ABSTRACT

A card and a process for making the card are provided. The card includes a card substrate and a flock transfer attached to a first surface of the card substrate. The flock transfer includes a plurality of flock fibers oriented predominately perpendicular to the first surface and bound together as a unit at a first end of each fiber by a binder adhesive layer positioned between the flock fibers and the first surface.

### CROSS-REFERENCE TO RELATED APPLICATION

This application claims priority from U.S. Provisional Application No. 60/816,701 filed Jun. 27, 2006.

### FIELD OF THE DISCLOSURE

The present disclosure relates to cards that carry information, such as stored value cards and other types of transaction cards. More particularly, the present disclosure relates to a card having decorative fibers.

### BACKGROUND OF THE DISCLOSURE

Many different types of stored value and other transaction cards are known in the industry today. Examples include gift cards, phone cards, credit cards, badges, identification cards, business cards and debit cards. Such cards typically include a plastic substrate and have information and designs or other artwork printed directly on the plastic substrate. Some cards include encoded information that can be stored on the plastic substrate in the form of a barcode or printed magnetic stripe.

Although the process for making a typical card is generally known in the industry today, there is a continuing desire to present new, original card designs and structures that generate or renew interest in such cards and result in continued strong sales and growth in the card industry. For example, Tomczyk U.S. Pat. No. 6,900,944, assigned to Travel Tags, Inc., discloses a lenticular card and a process for making the card. The lenticular card includes a plastic substrate and a lenticular lens attached to the substrate for creating interesting visual effects.

Further card appearance features are desired to allow card manufacturers, marketers and end-users to differentiate themselves in the marketplace and to create interest in their cards.

### SUMMARY

An aspect of the present disclosure is directed to a card, which includes a card substrate and a flock transfer attached to a first surface of the card substrate. The flock transfer includes a plurality of flock fibers oriented predominately perpendicular to the first surface and bound together as a unit at a first end of each fiber by a binder adhesive layer positioned between the flock fibers and the first surface.

Another aspect of the present disclosure is directed to a process, which includes attaching a flock transfer to a first surface of a card substrate. The flock transfer includes a release sheet, a release adhesive layer adhered to the release sheet and a flock layer having flock fibers adhered to the release adhesive layer along a front surface of the flock layer. A binder adhesive layer is adhered to a back surface of the flock layer and binds the flock fibers as a unit. The process further includes removing the release sheet and the release adhesive layer from the flock transfer to expose the front surface of the flock layer.

### BRIEF DESCRIPTION OF THE DRAWINGS

FIGS. 1A and 1B illustrate top and bottom plan views of a flocked gift card, according to an aspect of the disclosure.

FIG. 2 is a cross-sectional view of the flocked card illustrated in FIGS. 1A and 1B.

FIG. 3 is a cross-sectional view of a flock transfer, which can be applied to a card substrate to form a flocked card, according to an aspect of the disclosure.

FIG. 4 is a diagram illustrating a process for applying flock fibers to an adhesive-coated release sheet according to an aspect of the disclosure.

FIG. 5 is a cross-sectional view illustrating the application of a flock transfer to the front surface of a card substrate, according to an aspect of the disclosure.

### DETAILED DESCRIPTION OF ILLUSTRATIVE EXAMPLES

The present disclosure describes various examples of a flocked card having structures and appearance features with interesting visual and tactile effects. Such features can be implemented with various different types of information-carrying cards such as stored value and other transaction cards. Examples of information-carrying cards include but are not limited to gift cards, phone cards, credit cards, badges, identification cards, business cards, credit/debit cards, security cards, novelty cards, playing cards, trading cards, promotion cards, membership cards, royalty cards and other cards.

1. Flocked Gift Card Example

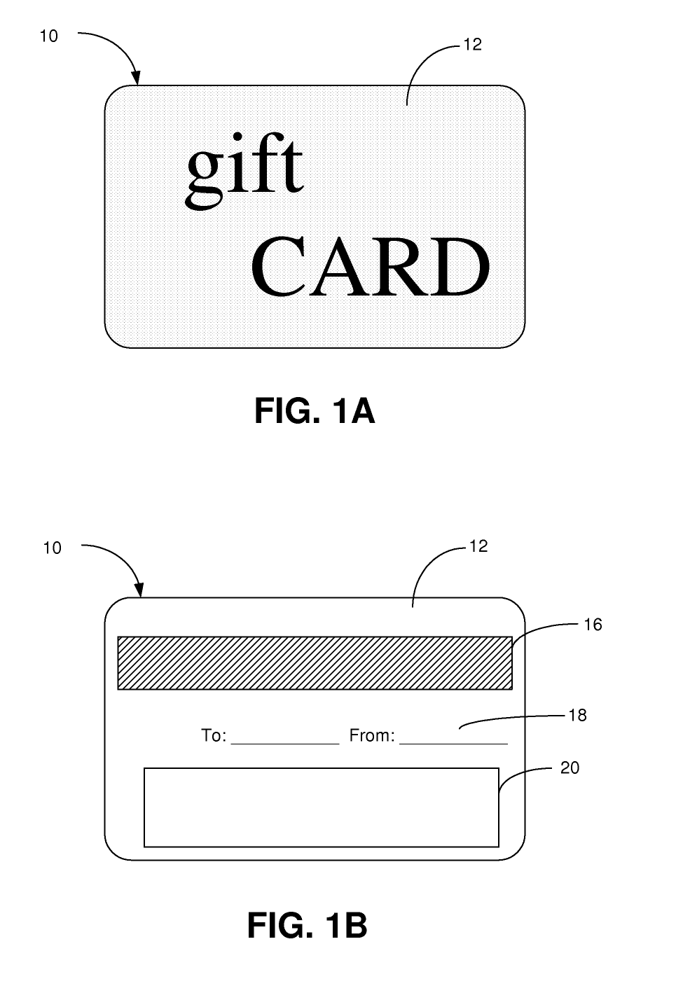

FIGS. 1A and 1B illustrate a flocked gift card 10, for carrying a stored transaction value according to an aspect of the present disclosure. FIG. 1A illustrates a top plan view of card 10, and FIG. 1B illustrates a bottom plan view of card 10. Card 10 has a decorative fiber layer 12 attached to a card substrate or card substrate 14. Decorative fiber layer 12 can cover an entire surface of card substrate 14 or can be limited to specific regions of the surface in various patterns. Decorative fiber layer 12 can also be combined with other appearance and functional features to achieve a variety of different visual, tactile and/or functional effects.

As shown in FIG. 1B, the back surface of card substrate 14 can optionally include further appearance and functional features, such as a machine-readable data storage element 16, a signature field 18, and a text field 20. Other designs or information fields can also be included on card substrate 14. In the example shown in FIG. 1B, data storage element 16 includes a machine-readable and writable magnetic stripe. Other types of data storage elements, such as a bar code, can also be used for storing encoded or unencoded information. Such features can also be applied to the front surface of card substrate 14, along with decorative fiber layer 12. These and other features can be applied by imaging, printing, molding, stamping, embossing, adhering or any other suitable process. For example, data storage element 16, signature field 18 and text field 20 can be printed on the card by thermal or inkjet imaging methods.

Flocked card 10 can have any dimensions, format and construction. In one or more examples, flocked card 10 has a compression lamination construction that meets the specifications of ISO/IEC 7810:1995(E) “Identification Cards-Physical Characteristics” and ISO/IEC 7816-1:1987(E) “Identification Cards-Integrated Circuit(s) Cards with Contacts.” The flocked card 10 can have, for example, a thickness of about 10 to about 40 mils (10×10⁻³ to 40×10⁻³ inches), such as a thickness of about 30 mils plus or minus about 1.5 mils, and a finished trim size, for example, of about 3⅜ inches long by about 2⅛ inches wide. Other card formats and dimensions can be used in alternative examples.

The flocked surface provided by decorative fiber layer 12 can provide one or more of the following performance characteristics:

1. Cushioning and protection;

2. Soft velvety finish;

3. Non-abrasive surface;

4. Protective finish;

5. Color ranges to match any décor or theme, including rich colors, pastel shades, iridescence, high sheen, matte finish, two-tone, soft and coarse effects on the substrate surface as well as many other effects;

6. Decorative and visual appeal, including atheistic effects, such as color and the rich look of textile versus plane flat plastic;

7. Tactile features such as texture, comfort and dimension;

8. Informational (e.g., airbag labels, badges, business cards, etc); and

9. Logo branding (vibrant use of a commercial trademark).

In general, flocking is a process whereby synthetic or natural pre-colored or post-colored fibers are electro-statically directly applied to another surface to achieve a velvet/suede type finish. An example of a traditional flocking method is known as “multi-color direct flocking”. The flock fibers are applied directly to the surface that forms the finished product. Wallpaper, carpets and decorate elements of garments are examples of products are produced in this manner. An adhesive is applied to the surface and then each color of flock is passed through a respective screen that restricts that color to the desired part of the adhesive layer. This produces a multicolor flock design on the surface.

However, these traditional flocking techniques could be problematic if applied to information-carrying cards such as stored value and other transactional cards. First, the fibers could “shed” causing dust or other particles to release from the flocked surface onto other surfaces. In the card industry, this is not preferable because the shedded fibers, dust or other particles could interrupt or contaminate card readers such as magnetic stripe readers and bar code readers. These particles could also shed onto other materials within the carrier's wallet or purse, causing a mess or even destroying other sensitive surfaces. Second, traditional flocking techniques are limiting in that the quality of the designs and logos can be distorted and/or not accurate due to a somewhat random fiber placement and orientation and due a difficulty in accurately printing color patterns on the flocked surface.

Today, it is important for businesses to have consistency with respect to the display and use of their logos and trademarks. The traditional methodologies do not allow for consistency and precision.

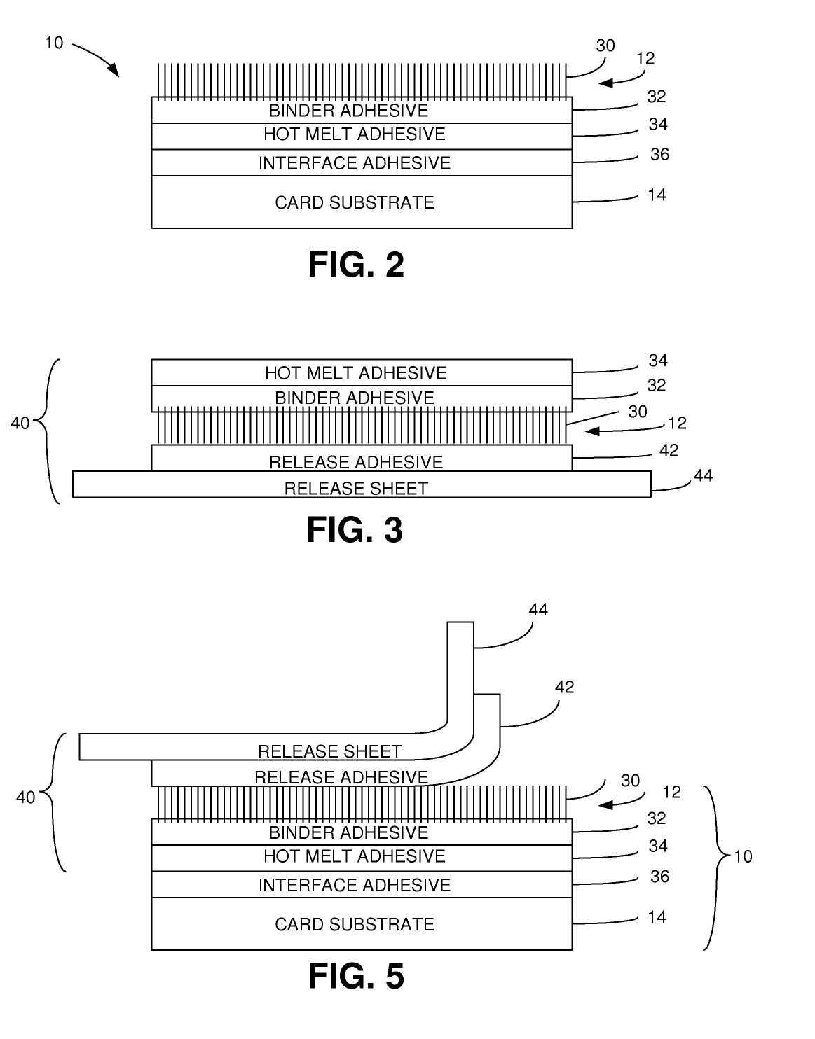

FIG. 2 is a cross-sectional view of flocked card 10 which is constructed such that the flock fibers are locked are locked into place and do not shed or shed very little. The flock has the precise and accurate placement of the various colors that makeup the desired design, logo or trademark.

The thicknesses of one or more layers in FIG. 2 are greatly exaggerated for clarity. In this example, decorative fiber layer 12 includes a flock 30 having a plurality of flock fibers adhered to a binder adhesive layer 32, which is adhered to or combined with a hot melt adhesive layer 34. An interface adhesive layer 36 adheres hot melt adhesive layer 34 and/or binder adhesive layer 32 to a front surface (or alternatively a back surface) of card substrate 14.

The fibers of flock 30 are oriented predominately perpendicular to the front surface of card substrate 14 and are bound together as a unit at a first end of each fiber by binder adhesive layer 32.

It has been found that the use of a flock transfer in which the flock fibers are locked into place by a binder adhesive layer, as shown in FIG. 2 and then transferred to card substrate 14 can provide a card with the benefits of a flocked layer while minimizing or eliminating traditional problems that had been observed with typical flocking methods.

Examples of flock transfers that have been found to be useful for attachment to a card such as card substrate 14 include the Lextra® brand flock transfer products manufactured by FiberLok, Inc., Fort Collins, Colo. Various features and examples of these flock transfers are described in one or more of the following U.S. Pat. Nos. 4,810,549, 5,047,103, 5,207,851, 5,346,746, 5,597,637, 5,858,156, 6,010,764, 6,083,332 and 6,110,560, which are assigned to High Voltage Graphics, Inc. and are hereby incorporated by reference.

2. Flock Transfer Example

FIG. 3 is a cross-sectional view of a flock transfer 40, which is described in U.S. Pat. No. 5,047,103 and can be used for applying a decorative fiber layer 12 to the surface of card substrate 14 in an example of the present disclosure. The same reference numerals are used in FIG. 3 as were used in FIG. 2 for the same or similar elements.

Flock transfer 40 includes a release sheet 44 to which a release adhesive 42 is applied. Release adhesive 42 can include a silicon wax or an acrylic, for example. In an example, release adhesive 42 includes a commercially available LR100 manufactured by Societe D'Enduction et de Flockage. Release sheet 44 can include any material to effect temporary adhesion to the flock fibers. Release sheet 44 can include paper, such as dimensionally stable processed paper, plastic film (such as polyester), resin sheets and/or metal foils.

Release sheet 44 can be transparent, translucent or opaque. Release adhesive 42 may be applied in the reverse in a desired pattern, which correspondences to the overall image to be formed by the flock fibers. However, the release adhesive 42 can be applied without regard to the desired overall design, for example by applying with rollers or spraying release sheet 44 with a coating of the release adhesive 42. The release adhesive may be applied in the form of a solution or emulation such as a resin or a copolymer of the types described in U.S. Pat. No. 5,047,103 (hereinafter the '103 patent), for example. Other adhesives can also be used. In one example, the release adhesive 42 is applied to the release sheet 44 at a thickness of less than about 10 percent of the length of the flock. Other thicknesses can also be used.

The flock fibers can include natural or synthetic fibers such as rayon and other types of conductive materials including nylon, polyamide, polyester and similar synthetic fibers. The flock fibers are applied to an activated release adhesive 42 by an electrostatic process, by spraying or by gravity such as sprinkling or vibrating the block onto the surface of release sheet 44. The release adhesive forms a releasable bond with the ends of the flock fibers. A releasable bond is a bond in which the release sheet 44 and the release adhesive 42 can be removed from the flock fibers without substantially damaging flock fibers 30 or release sheet 44.

In one or more examples, an electrostatic process utilizes a field of static electricity to orient the flock fibers relative to the field and promote a perpendicular alignment of the fibers with respect to release sheet 44. For example, the adhesive-coated release sheet 44 can be passed between the potentials of a high voltage electrostatic field. An electrode 57 is utilized to give the flock a charge. The charged fibers become aligned with the electrical field lines of force. The release sheet 44 and/or the grounded parts of the machine form a ground potential. The flock fibers are therefore attracted toward the adhesive where they become embedded. With this process, most fibers adhering to the release adhesive 42 are oriented predominately perpendicular to release sheet 44, thus resulting is a dense pile finish.

In an alternative example, the flock fibers are non-conductive, and the fibers are transported and aligned predominately perpendicular to the release sheet through mechanical means.

3. Fabricating Flock Transfer

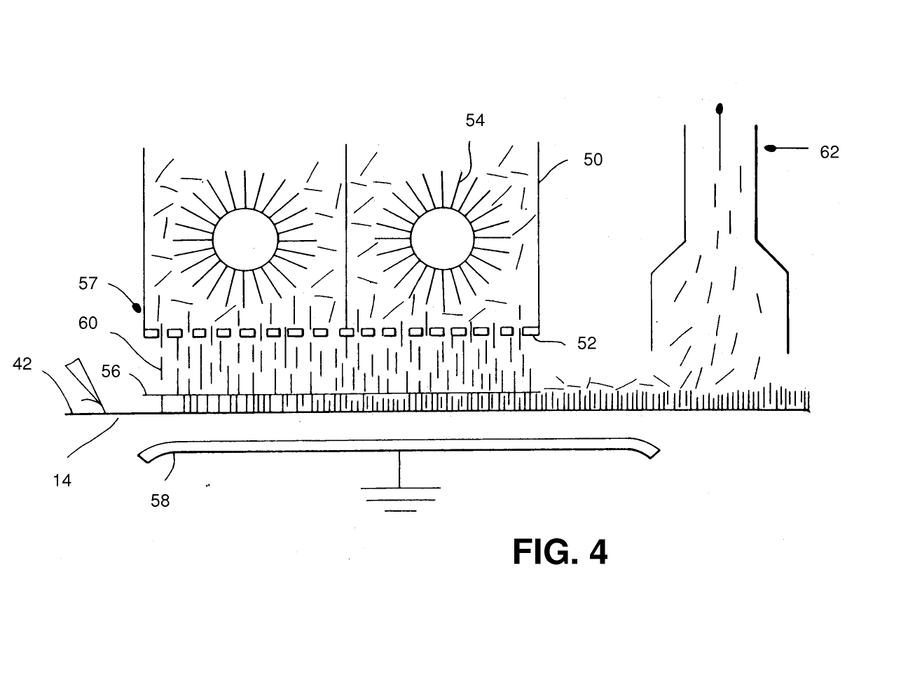

FIG. 4 is a diagram illustrating a process described in the above-referenced '103 patent that can be used for applying the flock fibers to the adhesive-coated release sheet 44 according to an example. Other processes can also be used. Flock fibers are dispensed from a hopper or box 50 by being physically pushed through a dispensing screen 52, which can be made of a metallic mesh by a rotating brush 54. The flock fibers passing through dispensing screen 52 enter an electrostatic field and pass through a barrier, such as an image screen 56. In one example image screen 56 is formed as a mesh screen. Image screen 56 is located between dispensing screen 52 and release sheet 44.

Image screen 56 is positioned closely adjacent release sheet 44, such as by a distance that is about equal to the length of the flock fibers being applied to the substrate, such as a distance about 110 percent of the length of the fibers.

The metallic dispensing screen 52 is connected to a high voltage source, such as an electrode 57, thereby creating a high voltage electrode that gives the flock fibers a charge, either positive or negative. The charged fibers are then attracted to image screen 56 and release sheet 44 through a counter potential provided by ground electrode 58. Fibers 60 either contact image screen 56 and reverse polarity and are then propelled again towards electrode dispensing screen 52 or, if they are propelled into release adhesive 32, they become permanent lodged in it and remain there, eventually forming the flock coating.

In one example, the flock fibers have an electronically conductive chemical finish coating to enable the fibers to become charged as well as to enable the fibers to continually change back and forth from a positive charge to a negative charge. The flock fibers 60 oscillate back and forth between the dispensing screen 52 and image screen 56 until the fibers eventually find a permanent location in release adhesive 42. Any remaining fibers not attached to release adhesive 42 can be removed by a vacuum source 62, for example.

In order to achieve a multicolor and/or textured effect, flock fibers 60 can be applied through sequential image screens 46. In one example, each image screen has a gauze-like mesh made of polyester monofilament material. A multicolor effect can be using different pre-colored flock. A textured effect can be achieved by using flock fibers of different lengths, wherein the flock fibers of substantially the same or uniform length are passed in batches through open sections of the image screen. An appropriate number of image screens can be made to have open sections to permit passage of flock in predetermined configurations, texture patterns and/or color patterns. Alternatively, a single screen may be sequentially masked for this purpose. The image screen also serves to mask areas that are not intended to receive a particular color or texture. Each different color and/or different length of flock can be applied sequentially using a different screen. The use of precolored flock avoids the need to print the flock with ink following flocking in order to effect different colors as in conventional direct flocking methods. Also, the length of the flock can be as long as practical for the transfer depending on the desired aesthetic effect.

Referring back to FIG. 3, flock fibers 60 of flock layer 30 are then coated with binder adhesive 32, such as a water-based acrylic, which binds the flock into a unit and forms a barrier for hot melt adhesive 34. The binder adhesive 32 can be applied in the form of a solution or emulsion. The binder adhesive can include a resin, such as polyvinyl chloride, polyvinyl acetate, polyurethane, polyester, polyamide, and acrylic resin, and the previously mentioned water-based acrylic. Examples of suitable binder adhesives are listed in the above-referenced '103 patent. Other binder adhesives can be used in alternative examples.

The binder adhesive 32 may include additional or supplemental adhesives, such as a hot melt adhesive, for binding the transfer 40 to a substrate. Hot melt adhesive 34 can include a granular polyester or nylon, for example. Alternatively, the hot melt adhesive 34 can form a separate layer as shown in FIG. 3. In addition, other heat sensitive adhesives can be used such as polyvinyl chloride, thermoplastic acrylic resin, polyethylene, polyamide, polyurethane, paraffin and rubber derivatives.

Once flock transfer 40 has been fabricated, the flock transfer can be used to transfer flock 30 to a substrate. The '103 patent recommends the application of heat and pressure to bond the hot melt adhesive 34 to the substrate material.

4. Applying Flock Transfer to Card Substrate

FIG. 5 is a cross-sectional view illustrating the application of flock transfer 40 to the front surface of card substrate 14 according to an aspect of the present disclosure. It has been found that the hot melt adhesive 34 of the Lextra® brand flock transfer does not reliably adhere to the face of card substrate 14 when passed through lamenting equipment used to manufacturer stored value or other transaction cards. An interface adhesive 36 was found to provide a suitable bond. The interface adhesive 36 can be applied to card substrate 14, hot melt adhesive 34 or both prior to bonding. For example, interface adhesive can be applied to card substrate 14 only prior to bonding flock transfer 40 to card substrate 14.

A variety of different interface adhesives can be used in alternative examples. For example, interface adhesive 36 can include a single part polyurethane adhesive, a two-part polyurethane adhesive, water-based polyurethane adhesive, solvent-based polyurethane adhesive, an epoxy, a moisture cure adhesive, a radiation cure adhesive, and an electron beam curable adhesive. For example, interface adhesive 36 may include a two-part polyurethane adhesive, such as PURELAM® A-9000 and A-9010 solvent-less laminating adhesives, which are commercially available from Ashland Inc. and are mixed in a ratio of two-to-one, respectively. Other mixing ratios can also be used in alternative examples. Also, other single-part and multiple-part adhesives can be used.

Interface adhesive 36 can be applied by automated printing, silk screening, roll coating, pad printing, spraying, or other methods of applying adhesives. Once interface adhesive 36 is applied to one or both of the card substrate 14 and the hot melt adhesive layer 34, flock transfer 40 is mated with card substrate 14 such that hot melt adhesive 34 contacts interface adhesive 36 and the two sheets are sufficiently aligned with one another. The combined flock transfer 40 and card substrate 14 are then passed through a nip roller, for example, which applies from about 0 bar to about 70 bar (0 to 1000 psi) of contact pressure to the paired sheets. For example, the applied pressure can be from about 0 bar to 10 bar, such as between 7 bar and 8.5 bar. Pressures outside these ranges can also be used.

The combined sheets are then left to cure at room temperature for about 24 hours, for example. Other types of curing can also be used, depending on the adhesive, and curing can include application of heat or ultraviolet radiation, for example.

In an alternative example, interface adhesive 36 includes a dual cure adhesive, such a 9340 adhesive made by Ashland Inc. Other dual cure adhesives can be used in further alternative examples. During a first processing stage, the adhesive is applied to card substrate 14 and/or hot melt adhesive 34 and then radiated with ultraviolet light. The ultraviolet light converts the glue to a tacky, pressure sensitive adhesive (PSA). Flock transfer 40 and card substrate 14 are then mated to one another, wherein the tackiness of the interface adhesive holds the pieces in place relative to one another. The combined sheets are then passed through a nip roller and then left to cure for suitable period of time, such as 24 hours. The fully cured interface adhesive becomes hard and stiff, thereby forming a permanent bond.

Preferred interface adhesives form a “destructive bond” between card substrate 14 and hot melt adhesive layer 34 and/or binder adhesive layer 32. A “destructive bond” is generally a type of adhesive bond that once formed between two joined sheets or surfaces cannot be mechanically separated or undone without accompanying destruction or damage to the two joined sheets or surfaces, wherein the destruction or damage is readily evident to an observer or detectable by a suitably-equipped detector device.

In a further alternative example, a film can be applied to hot melt adhesive layer 34 of flock transfer 40. The film can include teslin, polyester or polycarbonate, for example. In a further alternative example, flock transfer 40 is fabricated without hot melt adhesive layer 34. In this example, the interface adhesive layer 36 adheres directly to binder adhesive layer 32.

Once interface adhesive 36 has cured, release sheet 44 with its release adhesive 42 is then pulled away from flock 30, as shown in FIG. 5. This leaves the remainder of transfer 40 permanently affixed to card substrate 14 to form a plush decorative fiber layer on flocked card 10.

The above process can be applied on an individual card basis or can be applied to a larger card substrate sheet (or to a continuous web) that is later divided into individual finished cards. For example, large sheets of flock transfers can be fabricated as shown in FIG. 4, with each sheet having an array of a plurality of flock transfer patterns. The large flock transfer sheets are mated with the large card substrate sheets as described above and passed through a nip roller to combine the sheets. For example, the paired sheets are jogged to a common guide and gripper so the flocked transfer is positioned relative to the card substrate sheet within a reasonable tolerance, for example, of about plus or minus 0.015 inches. The sheets can then be left at ambient temperatures of about 25° C. to complete polymerization and full cure.

The combined sheets can then be divided into individual cards by cutting the cards with an on-line splitter or punching the cards punch press, for example, such as with a male/female punch, a steel rule die cut or a Print Machinery Company (PMC) die, which is a hollow steel die process. Alternatively, individual flock transfers can be mated with individual card substrates.

The resulting cards are then magnetically striped by applying a one-half inch wide (for example) magnetic film using a hot stamp print machine, such as a Franklin Magnetic Stripe Applicator. An alternative process includes laminating the card substrate using a flush magnetic laminate film, wherein the magnetic material is incorporated into the laminate to eliminate a separate step of applying a magnetic strip. Cards can then be thermally imaged and encoded using a Data Card Machine.

5. Fabrication of Card Substrate

Card substrate 14 can be fabricated in any suitable manner. In one example, card substrate 10 is fabricated according to the processes and materials described in U.S. Pat. No. 6,900,944, which is hereby incorporated by reference.

Card substrate 14 can include any suitable material. In one example, card substrate 14 includes a plastic sheet that can be thermally imaged and can be hot stamped, such as with encodable magnetic stripe 16. Generally, for card 10 to be thermally imaginable, the surface to the imaged should be very smooth and the plastic should be able to withstand the elevated temperatures of the thermal imaging process. Thermal imaging processes work well on, for example, laminated vinyl, polyester or co-polyester, such as polyethylene terephthalate glycol (PETG) and amorphous polyethylene terephthalate (APET, also known as poly (oxyethyleneoxyterephthaloyl)). For example, PVC backing sheet material that is commercially available from Goex of Janesville, Wis. was found to be suitable material because of its bonding and imaging properties.

Thus in the above-mentioned processes, the card substrate can include, for example, paper, resin, plastic, glass, rubber, methyl, alloy, or combinations thereof. Examples include but are not limited to, polystyrene, polyvinyl choride (PVC), PVC laminated polystyrene, compression laminated polystyrene, compression laminated PVC, polyester, polyolefins such as polyethylene, polypropylene, and the like, Acrylonitrile butadiene styrene (ABS), acrylics, epoxies, polyurethanes, polycarbonates, or combinations or laminates thereof. Card substrate 14 can be opaque, transparent or semitransparent.

The printed image areas on the front or back surfaces of card substrate 14 or other layers of card 10 can be applied by any suitable method, such as thermal imaging and/or ink jet printing. Various types of inks can be used, such as one or more conventional lithographic-ink formulations or UV curable inks. For example, the printed image areas can include one or many colored inks, such as those colors available from Pantone, Inc. Carlstadt, N.J., other suppliers, and combinations thereof. Other suppliers of suitable inks include Sun Chemical of Parsippany, N.J. (which manufactures the SUNCURE brand of UV curable inks) and Flint Inks of St. Paul, Minn.

6. Further Examples

The resulting flocked cards can be manufactured to suit any desired consumer or industry need. For example, the cards can be manufactured as a secure card article, which can be tamper resistant, tamper evident. The thickness of the card and the materials used to fabricate the card can be varied as desired. With the Lextra® brand flock transfer, for example, the flock layer can be made thicker or thinner by adding more or less fibers or by using longer or shorter fiber lengths. Various contoured surface features can also be achieved by cutting fibers in a desired pattern to create varying fiber lengths and cutout designs, such as by laser cutting. Open, non-flocked areas can be made by cutting fibers after fabrication or by patterning the flock fibers during manufacturer of the flock transfer.

The resulting flocked surface can include various designs, logos and trademarks to suit a customer's needs. Card substrate 14 can include one or more additional layers to provide visual effects or features within the open areas. For example, card substrate 14 can include ink, foil, etc. within the open areas on the front or back surfaces of the card. Additional material can be applied within the open areas prior or subsequent to applying the flock transfer to the card substrate.

As result, cards can be made with a decorative fiber layer that enables new and original design ideas that can be used to create market interest in the cards, resulting in continued strong sales and growth in the card industry. Such cards can have a hard-wearing, soft, velvety, textured surface that can transform an otherwise plain, flat and shiny plastic card into a rich, warm, intensely-colored, comfortable and visually compelling surface.

Although the present disclosure has been described with reference to one or more examples, workers skilled in the art will recognize that changes may be made in form and detail without departing from the scope of the disclosure and/or the appended claims. It is to be understood that the subject matter defined in the appended claims is not limited to the specific features or acts described above, which are provided as non-limiting examples.

What is claimed is:

1. A card comprising:
a card substrate; and
a flock transfer attached to a first surface of the card substrate and comprising a plurality of flock fibers oriented predominately perpendicular to the first surface and bound together as a unit at a first end of each fiber by a binder adhesive layer positioned between the flock fibers and the first surface.

2. The card of claim 2 and further comprising:
an interface adhesive layer adhered to and forming a destructive bond with the first surface of the card substrate, between the binder adhesive layer and the first surface.

4. The card of claim 2 wherein the interface adhesive layer comprises an adhesive selected from the group comprising a single part polyurethane adhesive, a two-part polyurethane adhesive, water-based polyurethane adhesive, solvent-based polyurethane adhesive, an epoxy, a moisture cure adhesive, a radiation cure adhesive, and an electron beam curable adhesive.

5. The card of claim 4 wherein the interface adhesive comprises a two-part polyurethane adhesive.

6. The card of claim 4 wherein the interface adhesive comprises a dual cure adhesive, which has a radiation cure stage and a room temperature cure stage.

7. The card of claim 2 wherein the flock transfer further comprises:
a hot melt adhesive combined with the binder adhesive layer or formed as a separate layer adhered to the binder adhesive layer between the binder adhesive layer and the first surface, wherein the hot melt adhesive is adhered to the interface adhesive layer.

8. The card of claim 1, wherein the card is in an intermediate state of manufacture and further comprises:
a release sheet attached by a release adhesive layer to second of the flock fibers that are opposite to the first ends and the binder adhesive layer, the release adhesive layer forming a releasable bond between the release sheet and the flock.

9. The card of claim 1 wherein the card substrate comprises elements selected from the group comprising polystyrene, polyvinylchloride (PVC), PVC laminated polystyrene, compression laminated polystyrene, compression laminated PVC, polyester, polyolefins, combinations thereof and laminates thereof.

10. The card of claim 1, wherein the card substrate elements selected from the group comprising paper, resin, plastic, glass, rubber, metal, alloy, combinations thereof and laminates thereof.

11. The card of claim 1, wherein the flock transfer covers substantially the entire first surface of the card substrate.

12. The card of claim 1, wherein the card substrate comprises a second surface, opposite to the first surface, which comprises at least one of an encodable magnetic stripe and a bar code.

13. The card of claim 1 wherein the card has a thickness of about 10 mils to about 40 mils.

14. The card of to claim 1 wherein the card has a length of about 3⅜ inches and a width of about 2⅛ inches.

15. The card of claim 1 wherein comprises a transaction card.

16. A process comprising:
attaching a flock transfer to a first surface of a card substrate, wherein the flock transfer comprises a release sheet, a release adhesive layer adhered to the release sheet, a flock layer comprising flock fibers adhered to the release adhesive layer along a front surface of the flock layer, a binder adhesive layer adhered to a back surface of the flock layer and binding the flock fibers as a unit; and
removing the release sheet and the release adhesive layer from the flock transfer to expose the front surface of the flock layer.

17. The process of claim 16 and further comprising:
applying an interface adhesive layer to at least one of the flock transfer and the card substrate prior to attaching the flock transfer to the card substrate, wherein the interface adhesive layer adheres the flock transfer to the card substrate after the step of attaching.

18. The process of claim 17 wherein the interface adhesive layer comprises an adhesive selected from the group comprising a single part urethane adhesive, a two-part urethane adhesive, an epoxy adhesive, a moisture cure adhesive, a radiation cure adhesive, an electron beam curable adhesive, and water-based urethane adhesive.

19. The process of claim 18 wherein the interface adhesive comprises a two-part urethane adhesive.

20. The process of claim 17 and further comprising:
partially curing the interface adhesive with radiation after the step of applying and prior to the step of attaching; and
further curing the interface adhesive after the step of attaching.

21. The process of claim 17 wherein the flock transfer comprises a hot melt adhesive forming part of the binder adhesive layer or a separate layer attached to the binder adhesive layer, wherein the interface adhesive layer forms a destructive bond between the hot melt adhesive the card substrate after the step of attaching the flock transfer to the card substrate.

22. The process of claim 17, wherein attaching comprises:
mating the flock transfer with the card substrate after applying the interface adhesive layer; and
nip rolling the flock transfer and the card substrate together.

23. The process of claim 16 and further comprising, after the step of attaching:
dividing the card substrate with the attached flock transfer into a plurality of individual flocked cards.

24. The process of claim 16 wherein the card substrate has length and width dimensions of an individual card product during the step of attaching.

25. The process of claim 16 and further comprising:
applying a machine-readable information carrier to a second surface of the card substrate, which is opposite to the first surface.

26. The process of claim 16, wherein the step of applying a machine-readable information carrier comprises applying at least one of an encodable magnetic stripe and a bar code to the second surface.
